(19) United States
(12) Patent Application Publication
(10) Pub. No.: US 2023/0324259 A1
(43) Pub. Date: Oct. 12, 2023

(54) MICROTOME

(71) Applicant: LEICA BIOSYSTEMS NUSSLOCH GMBH, Nussloch (DE)

(72) Inventors: ZheGuang FAN, Shanghai (CN); HongJian TAO, Shanghai (CN); Song JIN, Shanghai (CN); Alice ZHANG, Shanghai (CN)

(21) Appl. No.: 18/022,289

(22) PCT Filed: Sep. 3, 2020
(86) PCT No.: PCT/CN2020/113228

§ 371 Date: Feb. 21, 2023

(51) Int. Cl. G01N 1/06; B26D 7/26

(52) U.S. Cl. CPC G01N 1/06; B26D 7/2614; G01N 2001/061

(57) ABSTRACT

A microtome includes a blade; and a knife holder. The blade has a cutting edge configured to section a specimen block. The knife holder includes a base, a pressure plate and a frame. The pressure plate is connected to the base, and the pressure plate is adjustable relative to the base to clamp the blade between base and the pressure plate. The frame includes at least one limb and a bridge extending from the at least one limb parallel to the cutting edge. The bridge is proximate the cutting edge, the bridge and the blade cooperatively define a first gap therebetween, and the bridge and the pressure plate cooperatively define a second gap therebetween.

### CROSS-REFERENCE TO RELATED APPLICATION

The present application is a national phase entry under 35 USC § 371 of International Application PCT/CN2020/113228, filed Sep. 3, 2020, the entire disclosure of which is incorporated herein by reference.

### FIELD

The present disclosure relates to a technical field of microtomy, and more particularly to a microtome.

### BACKGROUND

In the related art, a microtome typically includes a blade, a knife holder, and an object carriage for carrying a specimen holder which holds a specimen block to be cut. The blade is clamped on the knife holder, and protrudes from the knife holder. The object carriage moves up and down in a vertical path of the microtome. During the vertical movement, the specimen block passes through the blade from an upper position to complete one section. An operator may be exposed to a risk of contacting the cutting edge of the blade.

U.S. Pat. No. 6,705,187 B2A relates to a device for stretching cryostatic sections. The device includes a sectioning knife and a plate. The plate is arranged on a back side of the sectioning knife so that a gap for receiving the cryostatic section is formed between the back of the sectioning knife and the plate. A frame, open in a direction of an edge of the knife, is provided for receiving the plate. The frame has internally located shaped-on webs having support surfaces to support the plate, and a contact rim for setting the frame onto the back of the sectioning knife. A height difference between the contact rim and the support surfaces defines a dimension of the gap.

U.S. Pat. No. 8,042,444 B2 relates to a knife holder for microtome blades. The knife holder has a body for reception of the blade against an abutment edge and a pressure plate for retention of the blade, such that in the retained state, only the blade cutting edge protrudes from the body. Articulated on pressure plate is a rectangular frame that is pivotable about a pivot axis, and a bridge of the rectangular frame extends over microtome blade and thus prevents inadvertent contact with the otherwise exposed blade cutting edge.

### SUMMARY

Embodiments of the present disclosure seek to solve at least one of the problems existing in the related art to at least some extent.

Embodiments of the present disclosure provides a microtome including a blade; and a knife holder. The blade has a cutting edge configured to section a specimen block. The knife holder includes a base, a pressure plate and a frame. The pressure plate is connected to the base, and the pressure plate is adjustable relative to the base to clamp the blade between base and the pressure plate. The frame includes at least one limb and a bridge extending from the at least one limb parallel to the cutting edge. The bridge is proximate the cutting edge, the bridge and the blade cooperatively define a first gap therebetween, and the bridge and the pressure plate cooperatively define a second gap therebetween.

In the microtome according to embodiments of the present disclosure, in the process of sectioning, the bridge is proximate the cutting edge of the blade, such that an operator can be protected from being accidentally injured by the cutting edge; the bridge of the frame and the blade cooperatively define the first gap therebetween, and the bridge of the frame and the pressure plate cooperatively define the second gap therebetween, the section cut from the specimen block can pass through the first gap and the second gap sequentially, thereby not affecting the workflow and efficiency of the microtome.

In at least one embodiment, the bridge is in front of and at a distance from the cutting edge in a front-rear direction, to avoid interfering with the vertical movement of the specimen block.

In at least one embodiment, the distance from the bridge to the cutting edge is greater than a thickness of a section to be cut from the specimen block. Thus, the bridge of the frame may be clear of the specimen block when the specimen block is passed through the cutting edge in the cutting direction, without hindering the vertical movement of the specimen block.

In at least one embodiment, a size of the first gap is greater than a thickness of a section to be cut from the specimen block, and a size of the second gap is greater than the thickness of the section to be cut from the specimen block. Similarly, the bridge of the frame may be clear of the section cut from the specimen block when the section goes through the first gap and the second gap sequentially, without hindering the movement of the section along a front face of the pressure plate.

In at least one embodiment, the knife holder further includes an ejection apparatus attached to the frame, and the ejection apparatus includes an ejection element carried by the frame and movable relative to the frame in a blade ejecting direction to eject the blade. Thus, when the blade is fully used, the ejection apparatus can eject the blade from the knife holder, without exposing the operator to the risk of contacting the cutting edge.

In at least one embodiment, the frame is U-shaped and the at least one limb includes a pair of limbs connected to one another by the bridge. Thus, the fame may have a robust structure to prevent the bridge from interfering with the specimen block, the blade, and the pressure plate.

In at least one embodiment, the frame is fixedly connected to one of the pressure plate and the base. When the frame is secured to the pressure plate, the second gap can be accurately determined and guaranteed; when the frame is secured to the base, the second gap is adjustable because the pressure plate is adjustable relative to the base.

In at least one embodiment, the frame is pivotally mounted to one of the pressure plate and the base for rotation about a pivot axis extending parallel to the cutting edge, the frame is pivotable between a first position where the bridge is proximate the cutting edge, the bridge and the blade cooperatively define a first gap therebetween, and the bridge and the pressure plate cooperatively define a second gap therebetween; and a second position where the bridge is distal from the cutting edge. Thus, the frame can be flexibly controlled, when the protection is needed the frame may be rotated to the first position, and when the protection is not needed the frame may be rotated to the second position.

In at least one embodiment, the knife holder further includes a first limiting member connected to one of the pressure plate and the base, and when the frame is in the first position, the frame abuts against the first limiting member. The first limiting member can determine the distance from the bridge to the cutting edge in the front-rear direction, the size of the first gap and the size of the second gap.

In at least one embodiment, the first limiting member is detachably connected to one of the pressure plate and the base. Thus, the first limiting member can be removed and replaced by another first limiting member having a different size, to adjust the distance from the bridge to the cutting edge in the front-rear direction, the size of the first gap and the size of the second gap.

In at least one embodiment, the frame is pivotally mounted to the base, the base defines a groove extending in a front-rear direction, a pivot end of the at least one limb is provided at a middle of the bottom of the groove, the groove has a first inclined bottom face extending upwards and rearwards from the middle of the bottom of the groove and a second inclined bottom face extending upwards and forwards from the middle of the bottom of the groove, the first limiting member is located at the first inclined bottom face; when the frame is in the first position, the at least one limb abuts against the first limiting member, and when in the second position, the at least one limb abuts against the second inclined bottom face.

In at least one embodiment, the knife holder further includes a second limiting member, the second limiting member is located at the second inclined bottom face; when in the second position, the at least one limb abuts against the second limiting member.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings.

FIG. 1 is a perspective view of a microtome according to an embodiment of the present disclosure, in which a frame is in a first position.

FIG. 2 is a perspective view of a microtome according to an embodiment of the present disclosure, in which a frame is in a second position.

FIG. 3 is a side view of a microtome according to an embodiment of the present disclosure, in which a frame is in a first position and some elements are omitted.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

It should be noted that, as used herein, the terms such as “upper”, “lower”, “left”, “right”, “front”, “rear” and the like are only for the purpose of illustration and are not intended to limit the present disclosure.

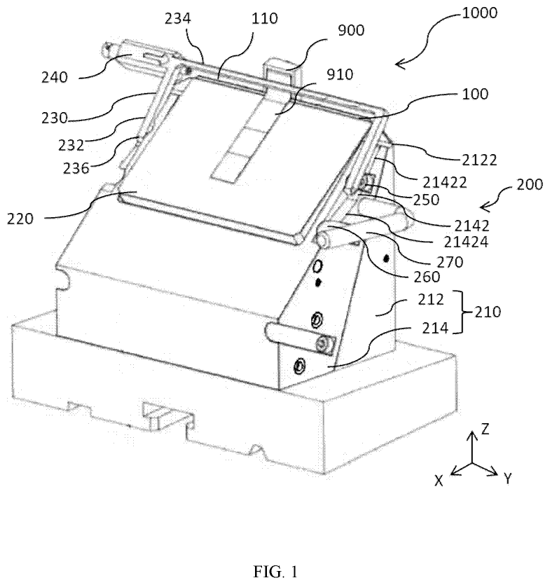

A microtome 1000 according to embodiments of the present disclosure will be described in detail below with reference to FIGS. 1 to 3. The orthogonal XYZ-axis is illustrated in order to facilitate the description and determine the directions. In which, the positive direction of the X-axis is the front direction and the negative direction of the X-axis is the rear direction; the positive direction of the Y-axis is the right direction and the negative direction of the Y-axis is the left direction; the positive direction of the Z-axis is the up direction and the negative direction of the Z-axis down direction.

According to embodiments of the present disclosure, as illustrated in FIGS. 1 to 3, the microtome 1000 includes a blade 100; and a knife holder 200. The blade 100 has a cutting edge 110 configured to section a specimen block 900. The knife holder 200 includes a base 210, a pressure plate 220 and a frame 230. The pressure plate 220 is connected to the base 210, and the pressure plate 220 is adjustable relative to the base 210 to clamp the blade 100 between base 210 and the pressure plate 220. The frame 230 includes at least one limb 232 and a bridge 234 extending from the at least one limb 232 parallel to the cutting edge 110. The bridge 234 is proximate the cutting edge 110, the bridge 234 and the blade 100 cooperatively define a first gap 300 therebetween, and the bridge 234 and the pressure plate 220 cooperatively define a second gap 400 therebetween.

It could be understood that, the cutting edge 110 of the blade 100 protrudes from the knife holder 200, and a section 910 can be cut from the specimen block 900 when the specimen block 900 is passed through the cutting edge 110 in a cutting direction, e.g. an up-down direction as illustrated in FIGS. 1 to 3.

In the microtome 1000 according to embodiments of the present disclosure, in the process of sectioning, the bridge 234 is proximate the cutting edge 110 of the blade 100, such that an operator can be protected from being accidentally injured by the cutting edge 110; the bridge 234 of the frame 230 and the blade 100 cooperatively define the first gap 300 therebetween, and the bridge 234 of the frame 230 and the pressure plate 220 cooperatively define the second gap 400 therebetween, the section 910 cut from the specimen block 900 can pass through the first gap 300 and the second gap 400 sequentially, thereby not affecting the workflow and efficiency of the microtome 1000.

In some embodiments, as illustrated in FIG. 3, the bridge 234 is in front of and at a distance from the cutting edge 110 in a front-rear direction.

It could be understood that, in the process of sectioning, the specimen block 900 is moved vertically to pass through the cutting edge 110 of the blade 100, to obtain a section 910 of the specimen block 900. The bridge 234 is in front of and at a distance from the cutting edge 110 in the front-rear direction, to avoid interfering with the vertical movement of the specimen block 900.

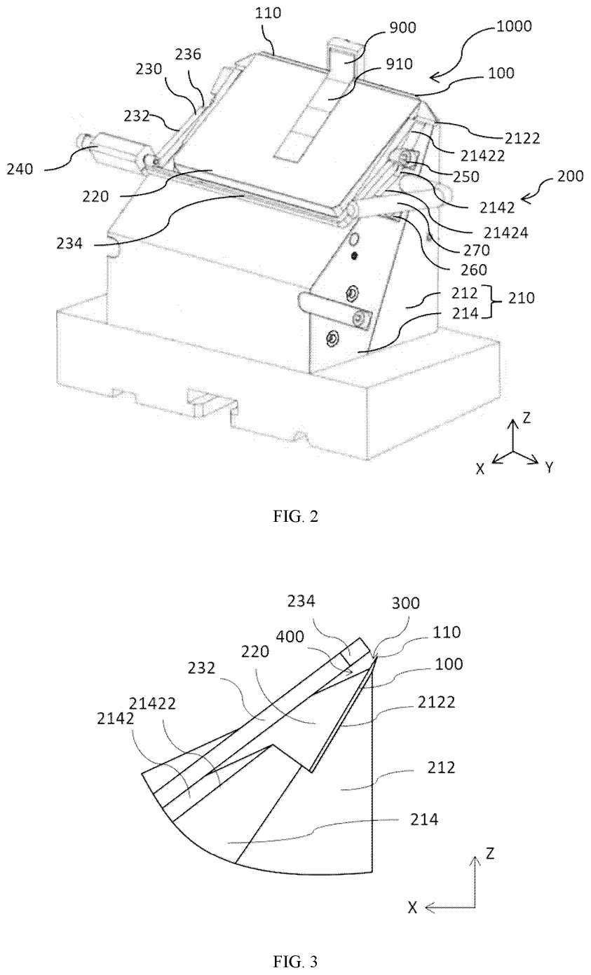

It should note that the front-rear direction refers to a direction perpendicular to an extending direction of the cutting edge 110 (e.g. a left-right direction as illustrated in FIGS. 1 and 2) and the cutting direction of the specimen block 900 simultaneously (e.g. the up-down direction as illustrated in FIGS. 1 to 3).

In some embodiments, as illustrated in FIG. 3, the bridge 234 is located above the cutting edge 110 and at a distance from the cutting edge 110 in an up-down direction, to prevent the operator from accessing the cutting edge 110 from above, thereby reducing risk of injury caused by the cutting edge 110.

In some embodiments, as illustrated in FIG. 3, the distance from the bridge 234 to the cutting edge 110 is greater than a thickness of a section 910 to be cut from the specimen block 900. Thus, the bridge 234 of the frame 230 may be clear of the specimen block 900 when the specimen block 900 is passed through the cutting edge 110 in the cutting direction, without hindering the vertical movement of the specimen block 900.

It should note that the distance from the bridge 234 to the cutting edge 110 refers to a minimum distance between the periphery of the bridge 234 and the cutting edge 110.

In some embodiments, as illustrated in FIG. 3, a size of the first gap 300 is greater than a thickness of a section 910 to be cut from the specimen block 900, and a size of the second gap 400 is greater than the thickness of the section 910 to be cut from the specimen block 900. Similarly, the bridge 234 of the frame 230 may be clear of the section 910 cut from the specimen block 900 when the section 910 goes through the first gap 300 and the second gap 400 sequentially, without hindering the movement of the section along a front face of the pressure plate 220.

It should note that the size of the first gap 300 refers to the minimum distance between the periphery of the bridge 234 and the blade 100, and the size of the second gap 400 refers to the minimum distance between the periphery of the bridge 234 and the pressure plate 220. In some embodiments, the cross section of the bridge 234 may have a rectangular shape. The cross section of the bridge 234 may also have any other suitable shape, such as a square shape, a circular shape, an oval shape, etc.

It could be understood that, the thickness of the section 910 to be cut from the specimen block 900 is typically in a range of 0.5 μm to 600 μm, and thus the distance from the bridge 234 to the cutting edge 110 in the front-rear direction, the size of the first gap 300 and the size the second gap 400 may be greater than 600 μm. For example, the distance from the bridge 234 to the cutting edge 110 in the front-rear direction, the size of the first gap 300 and the size of the second gap 400 may be 1 mm.

Furthermore, the distance from the bridge 234 to the cutting edge 110 in the front-rear direction, the size of the first gap 300 and the size of the second gap 400 may be the same, or the distance from the bridge 234 to the cutting edge 110 in the front-rear direction, the size of the first gap 300 and the size of the second gap 400 may be different.

In some embodiments, as illustrated in FIGS. 1 and 2, the knife holder 200 further includes an ejection apparatus 240 attached to the frame 230, and the ejection apparatus 240 includes an ejection element carried by the frame 230 and movable relative to the frame 230 in a blade ejecting direction to eject the blade 100. The blade 100 is generally disposable, and when the blade 100 is fully used, the ejection apparatus 240 can eject the blade 100 from the knife holder 200, without exposing the operator to the risk of contacting the cutting edge 110.

It should note that the blade ejecting direction may be the same as the extending direction of the cutting edge 110, i.e. the left-right direction as illustrated in FIGS. 1 and 2.

In some embodiments, as illustrated in FIGS. 1 and 2, the frame 230 is U-shaped and the at least one limb 232 includes a pair of limbs 232 connected to one another by the bridge 234. Thus, the fame 230 may have a robust structure to prevent the bridge 234 from interfering with the specimen block 900, the blade 100 and the pressure plate 220.

In some embodiments, as illustrated in FIGS. 1 and 2, the frame 230 is fixedly connected to one of the pressure plate 220 and the base 210. That is, the frame 230 may be secured to the pressure plate 220, or the frame 230 may be secured to the base 210. It could be understood that, when the frame 230 is secured to the pressure plate 220, the second gap 400 can be accurately determined and guaranteed; when the frame 230 is secured to the base 210, the second gap 400 is adjustable because the pressure plate 220 is adjustable relative to the base 210.

In some embodiments, as illustrated in FIGS. 1 and 2, the frame 230 is pivotally mounted to one of the pressure plate 220 and the base 210 for rotation about a pivot axis 236 extending parallel to the cutting edge 110, the frame 230 is pivotable between a first position where the bridge 234 is proximate the cutting edge 110, the bridge 234 and the blade 100 cooperatively define a first gap 300 therebetween, and the bridge 234 and the pressure plate 220 cooperatively define a second gap 400 therebetween; and a second position where the bridge 234 is distal from the cutting edge 110. That is, the frame 230 may be pivotally mounted to the pressure plate 220, or the frame 230 may be pivotally mounted to the base 210. Thus, the frame 230 can be flexibly controlled, when the protection is needed the frame 230 may be rotated to the first position, and when the protection is not needed the frame 230 may be rotated to the second position.

In some embodiments, as illustrated in FIGS. 1 and 2, the knife holder 200 further includes a first limiting member 250 connected to one of the pressure plate 220 and the base 210, and when the frame 230 is in the first position, the frame 230 abuts against the first limiting member 250. That is, the first limiting member 250 may be connected to the pressure plate 220, or the first limiting member 250 may be connected to the base 210. It could be understood that the first limiting member 250 can determine the distance from the bridge 234 to the cutting edge 110 in the front-rear direction, the size of the first gap 300 and the size of the second gap 400.

In some embodiments, as illustrated in FIGS. 1 and 2, the first limiting member 250 is detachably connected to one of the pressure plate 220 and the base 210. That is, the first limiting member 250 may be detachably connected to the pressure plate 220, or the first limiting member 250 may be detachably connected to the base 210. It could be understood that the first limiting member 250 can be removed and replaced by another first limiting member 250 having a different size, to adjust the distance from the bridge 234 to the cutting edge 110 in the front-rear direction, the size of the first gap 300 and the size of the second gap 400. For example, the first limiting member 250 may be a screw.

In some embodiments, as illustrated in FIGS. 1 and 2, the frame 230 is pivotally mounted to the base 210, the base 210 defines a groove 2142 extending in the front-rear direction, a pivot end of the at least one limb 232 is provided at a middle of the bottom of the groove 2142, the groove 2142 having a first inclined bottom face 21422 extending upwards and rearwards from the middle of the bottom of the groove 2142 and a second inclined bottom face 21424 extending upwards and forwards from the middle of the bottom of the groove 2142, the first limiting member 250 is located at the first inclined bottom face 21422; when the frame 230 is in the first position, the at least one limb 232 abuts against the first limiting member 250, and when in the second position, the at least one limb 232 abuts against the second inclined bottom face 21424.

In some embodiments, as illustrated in FIGS. 1 and 2, the knife holder 200 further includes a second limiting member 260, the second limiting member 260 is located at the second inclined bottom face 21424; when in the second position, the at least one limb 232 abuts against the second limiting member 260.

A microtome 1000 according to an embodiment of the present disclosure will be described in detail below with reference to FIGS. 1 to 3.

As illustrated in FIGS. 1 to 3, a microtome 1000 includes a blade 100; and a knife holder 200. The blade 100 has a cutting edge 110 configured to section a specimen block 900. The knife holder 200 includes a base 210, a pressure plate 220 and a frame 230.

The base 210 includes a blade clamping base 212 and a knife holder base 214, the blade clamping base 212 is fixedly connected to the knife holder base 214. The blade clamping base 212 defines a slot 2122 extending laterally in the top thereof. The blade 100 is received in the slot 2122 of the blade clamping base 212, and the cutting edge 110 of the blade 100 protrudes from the knife holder 200.

The pressure plate 220 is connected to the knife holder base 214, and the pressure plate 220 is adjustable relative to the knife holder base 214 to clamp the blade 100 between the blading clamping base 212 and the pressure plate 220.

The frame 230 is U-shaped, and includes two limbs 232 and a bridge 234 connected between the two limbs 232. The bridge 234 extends parallel to the cutting edge 110. The frame 230 is pivotally mounted to the knife holder base 214 for rotation about a pivot axis 236 extending parallel to the cutting edge 110. The frame 230 is pivotable between a first position where the bridge 234 is proximate the cutting edge 110, the bridge 234 and the blade 100 cooperatively define a first gap 300 therebetween, and the bridge 234 and the pressure plate 220 cooperatively define a second gap 400 therebetween, as illustrated in FIG. 1; and a second position where the bridge 234 is distal from the cutting edge 110, as illustrated in FIG. 2.

As illustrated in FIG. 3, the bridge 234 is in front of and at a distance from the cutting edge 110 in a front-rear direction; and the bridge 234 is located above and at a distance from the cutting edge 110 in an up-down direction. The distance from the bridge 234 to the cutting edge 110 in the front-rear direction is greater than a thickness of a section 910 to be cut from the specimen block 900. A size of the first gap 300 is greater than a thickness of a section 910 to be cut from the specimen block 900, and a size of the second gap 400 is greater than the thickness of the section 910 to be cut from the specimen block 900.

As illustrated in FIGS. 1 and 2, the knife holder 200 further includes an ejection apparatus 240 attached to the frame 230, and the ejection apparatus 240 includes an ejection element carried by the frame 230 and movable relative to the frame 230 in a blade ejecting direction, i.e. a left-right direction to eject the blade 100.

The knife holder base 214 defines two grooves 2142 extending in the front-rear direction, and the two grooves 2142 are located oppositely in the left-right direction relative to the pressure plate 220. Each groove 2142 has a first inclined bottom face 21422 extending upwards and rearwards from the middle of the bottom of the groove 2142 and a second inclined bottom face 21424 extending upwards and forwards from the middle of the bottom of the groove 2142. The two first inclined bottom faces 24122 coincide with each other in the left-right direction, and the two second inclined bottom faces 21424 coincide with each other in the left-right direction. Pivot ends of the two limbs 232 are located at the middle of the bottoms of the two grooves 2142, respectively.

The knife holder 200 further includes two first limiting members 250, and each of the first limiting member 250 is located at the first inclined bottom face 21422 of the corresponding groove 2142. The two first limiting members 250 are aligned with each other in the left-right direction.

The knife holder 200 further includes two second limiting members 260, and each of the second limiting member 260 is located at the second inclined bottom face 21424 of the corresponding groove 2142. The two second limiting members 260 are aligned with each other in the left-right direction.

When the frame 230 is in the first position, the two limbs 232 abut against the two first limiting members 232, respectively, and when in the second position, the two limbs 232 abut against the two second limiting members 260, respectively.

The knife holder 200 further includes a clamping toggle 270, and the pressure plate 220 may be pressured on the base 210 or released from the base 210 with the aid of the clamping toggle 270.

Other structures and principles of a tissue processor can be acknowledged by a person skilled in the art, which will not be elaborated herein.

The work process of the microtome 1000 will be briefly described below.

In order to perform the sectioning process, a blade 100 is received in the slot 2122 of the blade clamping base 212 and tightly clamped between the pressure plate 220 and the blade clamping base 212 by operating the clamping toggle 270, and the frame 230 is rotated to the first position. During the sectioning process, the specimen block 900 is passed through the cutting edge 110 in the up-down direction from an upper position. Since the bridge 234 is at a distance from the cutting edge 110 in the front-rear direction, the vertical movement of the specimen block 900 will not be hindered. After one section 910 is completed, the specimen block 900 is located below the cutting edge 110. In order to avoid interference with the cutting edge 110 when the specimen block is moved back to the original upper position, the specimen block 900 is moved first rearwards, then upwards until the specimen block 900 is above the cutting edge 110, and finally forwards to the original upper position for next sectioning. Since the bridge 234 of the frame 230 and the blade 100 cooperatively define the first gap 300 therebetween, and the bridge 234 of the frame 230 and the pressure plate 220 cooperatively define the second gap 400 therebetween, the section 910 cut from the specimen block 900 can pass through the first gap 300 and the second gap 400 sequentially along the front face of the pressure plate 220. Since the bridge 234 is located above the cutting edge 110 and at a distance from the cutting edge 110 in the up-down direction, the operator can be prevented accessing the cutting edge 110 from above during operations on the knife holder 200, e.g. the operator helps in moving the sections 910 along the front face of the pressure plate 220.

In other processes of the microtome 1000 that do not need the protection of the frame 230, the frame 230 may be rotated to the second position.

In general, the microtome 1000 according to embodiments of the present disclosure can reduce the risk of injury to the operator caused by the cutting edge 110 while ensuring the normal workflow and efficiency of the microtome 1000.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the present disclosure, the term “a plurality of” means two or more than two, unless specified otherwise.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A microtome, comprising:
a blade having a cutting edge configured to section a specimen block; and
a knife holder comprising:
a base;
a pressure plate connected to the base, the pressure plate being adjustable relative to the base to clamp the blade between base and the pressure plate; and
a frame comprising at least one limb and a bridge extending from the at least one limb parallel to the cutting edge,
wherein the bridge is proximate the cutting edge, the bridge and the blade cooperatively define a first gap therebetween, and the bridge and the pressure plate cooperatively define a second gap therebetween.

2. The microtome according to claim 1, wherein the bridge is in front of and at a distance from the cutting edge in a front-rear direction.

3. The microtome according to claim 2, wherein the distance from the bridge to the cutting edge in the front-rear direction is greater than a thickness of a section to be cut from the specimen block.

4. The microtome according to claim 1, wherein a size of the first gap is greater than a thickness of a section to be cut from the specimen block, and a size of the second gap is greater than the thickness of the section to be cut from the specimen block.

5. The microtome according to claim 1, wherein the knife holder further comprises an ejection apparatus attached to the frame, and the ejection apparatus comprises an ejection element carried by the frame and movable relative to the frame in a blade ejecting direction to eject the blade.

6. The microtome according to claim 1, wherein the frame is U-shaped and the at least one limb comprises a pair of limbs connected to one another by the bridge.

7. The microtome according to claim 1, wherein the frame is fixedly connected to one of the pressure plate and the base.

8. The microtome according to claim 1, wherein the frame is pivotally mounted to one of the pressure plate and the base for rotation about a pivot axis extending parallel to the cutting edge, the frame is pivotable between a first position where the bridge is proximate the cutting edge, the bridge and the blade cooperatively define the first gap therebetween, and the bridge and the pressure plate cooperatively define the second gap therebetween, and a second position where the bridge is distal from the cutting edge.

9. The microtome according to claim 8, wherein the knife holder further comprises a first limiting member connected to one of the pressure plate and the base, when the frame is in the first position, the frame abuts against the first limiting member.

10. The microtome according to claim 9, wherein the first limiting member is detachably connected to one of the pressure plate and the base.

11. The microtome according to claim 9, wherein the frame is pivotally mounted to the base, the base defines a groove extending in a front-rear direction, a pivot end of the at least one limb is provided at a middle of the bottom of the groove, the groove having a first inclined bottom face extending upwards and rearwards from the middle of the bottom of the groove and a second inclined bottom face extending upwards and forwards from the middle of the bottom of the groove, the first limiting member being located at the first inclined bottom face; wherein when the frame is in the first position, the at least one limb abuts against the first limiting member, and when the frame is in the second position, the at least one limb abuts against the second inclined bottom face.

12. The microtome according to claim 11, wherein the knife holder further comprises a second limiting member located at the second inclined bottom face; wherein when the frame is in the second position, the at least one limb abuts against the second limiting member.
